(19) United States
(12) Patent Application Publication
(10) Pub. No.: US 2011/0125598 A1
(43) Pub. Date: May 26, 2011

(54) SYSTEM AND METHOD FOR MANAGING ELECTRONIC RECEIPTS OF SALES TRANSACTIONS USING MOBILE DEVICES

(76) Inventors: Ji Hoon Shin, Seoul (KR); Jin Lee, Palo Alto, CA (US)

(21) Appl. No.: 12/625,540

(22) Filed: Nov. 24, 2009

(51) Int. Cl. G06Q 10/00; G06Q 20/00; G06Q 30/00; H04B 5/00

(52) U.S. Cl. 705/17; 705/21; 705/24; 705/30; 455/41.1

(57) ABSTRACT

A system and method for managing electronic receipts of sales transactions utilizes a receipt capture device that generates receipt data using information from a point-of-sales (POS) terminal and a mobile device that receives the receipt data from the receipt capture device using short range communication.

### FIELD OF THE INVENTION

The present invention relates to a system and method for managing sale transaction data, and more particularly, to a system and method for managing electronic receipts of sales transactions.

### BACKGROUND OF THE INVENTION

Using conventional point-of-sale (POS) systems, customers currently receive paper receipts from merchant stores after sales transactions, i.e., purchases, are made. A conventional POS system typically includes a POS terminal, its peripheral devices and remote transaction authorization servers of credit/debit card companies based on payment networks. The data for sales transactions is usually stored in a storage device of the POS terminal, which may be uploaded to one of the remote transaction authorization server or another remote server of the credit/debit card companies.

One of the drawbacks to the use of paper receipts provided by the conventional POS systems is that the customers need to physically possess the paper receipts in usable form since these paper receipts are required for refund, exchange, bookkeeping, and so on. This requirement can be burdensome for the customers because the customers have to manage the paper receipts so that the receipts do not get lost, worn or damaged.

Another drawback to the use of paper receipts is that, unlike credit/debit transactions, individual cash transactions are not stored in the conventional POS systems. Customers can read their own credit/debit transaction data at the websites of their banks or credit card companies. However, since the cash transactions are not stored, the paper receipts are the only record of these cash transactions.

Thus, there is a need for a system and method for managing electronic receipts of sales transactions that overcomes the above drawbacks.

### SUMMARY OF THE INVENTION

A system and method for managing electronic receipts of sales transactions utilizes a receipt capture device that generates receipt data using information from a point-of-sales (POS) terminal and a mobile device that receives the receipt data from the receipt capture device using short range communication.

A method for managing electronic receipts of sales transactions in accordance with an embodiment of the invention comprises generating receipt data for a sales transaction using information regarding the sales transaction from a point-of-sales (POS) terminal at a receipt capture device operably connected to the POS terminal, transmitting the receipt data using short range communication from the receipt captured device to a mobile device for storage, retrieving the receipt data from storage to the mobile device, and composing a visual receipt using the receipt data on a display of the mobile device for usage.

A system for managing electronic receipts of sales transactions in accordance with an embodiment of the invention comprises a POS terminal, a receipt capture device operably connected to the POS terminal and a mobile device. The receipt capture device is configured to generate receipt data for a sales transaction using information regarding the sales transaction from the POS terminal. The receipt capture device is further configured to transmit the receipt data using short range communication. The mobile device is configured to receive the receipt data using the short range communication with the receipt capture device. The mobile device is further configured to compose a visual receipt for the sales transaction using the receipt data on a display of the mobile device for usage.

A receipt capture device in accordance with an embodiment of the invention comprises a controller unit operably connected to a POS terminal and a storage unit. The controller unit is configured to receive information regarding a sales transaction from the POS terminal. The controller unit is further configured to generate receipt data for the sales transaction using the information from the POS terminal and to store the receipt data in the storage unit. The controller unit is further configured to transmit the receipt data to a mobile device using short range communication. The controller unit is further configured to selectively delete the receipt data from the storage unit after the receipt data has been transmitted to the mobile device according to an established receipt management rule. The controller unit is further configured to store receipt data for multiple sales transactions in a sequential manner and to associate the receipt data for the multiple sales transactions with unique user identifiers to distinguish each sales transaction. The controller unit is further configured to be able to upload and download the receipt data for any sales transaction to and from a remote server to avoid overflow of data at the storage unit.

A computer readable medium in accordance with an embodiment tangibly embodies a program of instructions executable by a processor of a mobile device to perform method steps for managing electronic receipts of sales transactions. The method steps comprises receiving receipt data for a sales transaction from a receipt capture device associated with a POS terminal using short range communication, storing the receipt data for the sales transaction received from the receipt capture device in a storage unit of the mobile device, composing a visual receipt for the sales transaction using the receipt data in the storage unit on a display of the mobile device, uploading the receipt data from the mobile device to a remote device for storage, including deleting the receipt data from the storage unit of the mobile device, and downloading the receipt data from the remote device to the mobile device.

A computer readable medium in accordance with an embodiment tangibly embodies a program of instructions executable by a processor of a computer to perform method steps for managing electronic receipts of sales transactions. The method steps comprises receiving receipt data for a sales transaction from a mobile device, storing the receipt data received from the mobile device in a storage unit of the computer, composing a visual receipt on a display of the personal computer using the receipt data, and transmitting the receipt data to the mobile device when requested by the mobile device.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows schematically a block diagram of a receipt management system in accordance with an embodiment of the invention.

FIG. 2 is a block diagram of a receipt capture device (RCD) of the receipt management system in accordance with an embodiment of the invention.

FIG. 3 is a block diagram of a mobile device of the receipt management system in accordance with an embodiment of the invention.

FIG. 4 is a block diagram of a receipt capture server (RCS) of the receipt management system in accordance with an embodiment of the invention.

FIG. 5 is a block diagram of a personal computer of the receipt management system in accordance with an embodiment of the invention.

FIG. 6 is a flow diagram of a process of managing (capturing, issuing and storing) electronic receipts using the receipt management system of FIG. 1 in accordance with a first embodiment of the invention.

FIG. 7 is a flow diagram of a process of managing (capturing, issuing and storing) electronic receipts using the receipt management system of FIG. 1 in accordance with a second embodiment of the invention.

FIG. 8 is a flow diagram of a process of managing (capturing, issuing and storing) electronic receipts using the receipt management system of FIG. 1 in accordance with a third embodiment of the invention.

FIGS. 9A and 9B are flow diagrams of a process of getting a refund/exchange using the receipt management system of FIG. 1 in accordance with an embodiment of the invention.

FIG. 10 is a flow diagram of a method for managing electronic receipts of sales transactions in accordance with an embodiment of the invention.

### DETAILED DESCRIPTION

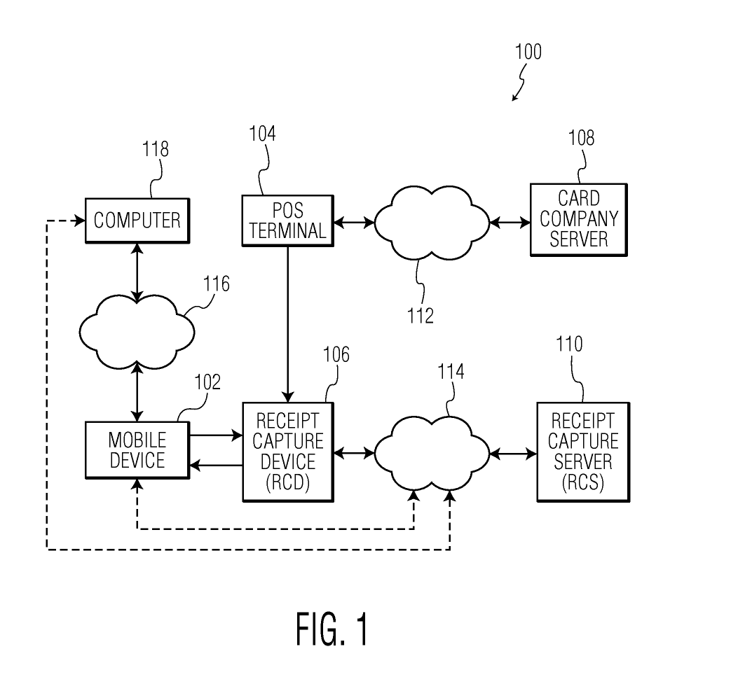

With reference to FIG. 1, a receipt management system 100 in accordance with an embodiment of the invention is described. As shown in FIG. 1, the receipt management system 100 includes a mobile device 102, a point-of-sale (POS) terminal 104, a receipt capture device (RCD) 106, a card company server 108 and a receipt capture server (RCS) 110. As described below, the receipt management system 100 generates electronic receipts for sales transactions, including credit/debit transactions and cash transactions, which can be accessed by and/or stored in the mobile device 102. Thus, the receipt management system 100 allows the user of the mobile device 102 to easily manage electronic receipts of sales transactions as needed without the need to have physical paper receipts of the sales transactions for various purposes, such as returning products for refund/exchange and managing expenses for tax purposes.

In the illustrated embodiment, the POS terminal 104 and the card company server 108 of the receipt management system 100 may be devices that can be currently found in a conventional POS system. The POS terminal 104 and the card company server 108 are connected to each other through a communication connection 112, which may be a connection via a payment network. The POS terminal 104 is an electronic device used by a merchant or any seller of goods and/or services to execute sales transactions, which may involve generating paper receipts and getting authorizations for credit/debit payments from the card company server 108. If credit/debit payments are used in the sales transactions, data for the transactions are stored in the card company server 108.

The RCD 106 of the receipt management system 100 is connected to the POS terminal 104 and the RCS 110 to communicate with these devices. As shown in FIG. 1, the RCD 106 is connected to the RCS 110 through a communication connection 114, which can be a connection via a cable link or via a network, such as a wired or wireless local area network (LAN). The RCD 106 is also designed to communicate with mobile devices of customers making sales transactions, such as the mobile device 102, as described in more detail below using the mobile device 102 as an example.

The RCD 106 is configured to capture or generate an electronic receipt for a sale transaction, which may be a cash transaction, executed using the POS terminal 104. An electronic receipt or data of a sales transaction can be considered an electronic version of a paper receipt that is commonly generated for a sales transaction. Thus, an electronic receipt can include information commonly found in a conventional paper receipt, as well as other information related to the associated sales transaction. An electronic receipt will be sometimes referred to herein as electronic receipt data. The generated electronic receipt data can then be transferred to the mobile device 102 for storage. Alternatively, the electronic receipt data may be transferred to another device for storage, such as the RCS 110, so that the electronic receipt data can be subsequently retrieved by the mobile device 102 as needed. Since the electronic receipt data is stored in the mobile device 102 and/or retrievable from the RCS 110 by the mobile device, the user of the mobile device can readily access the electronic receipt data, for example, to return products for refund/exchange.

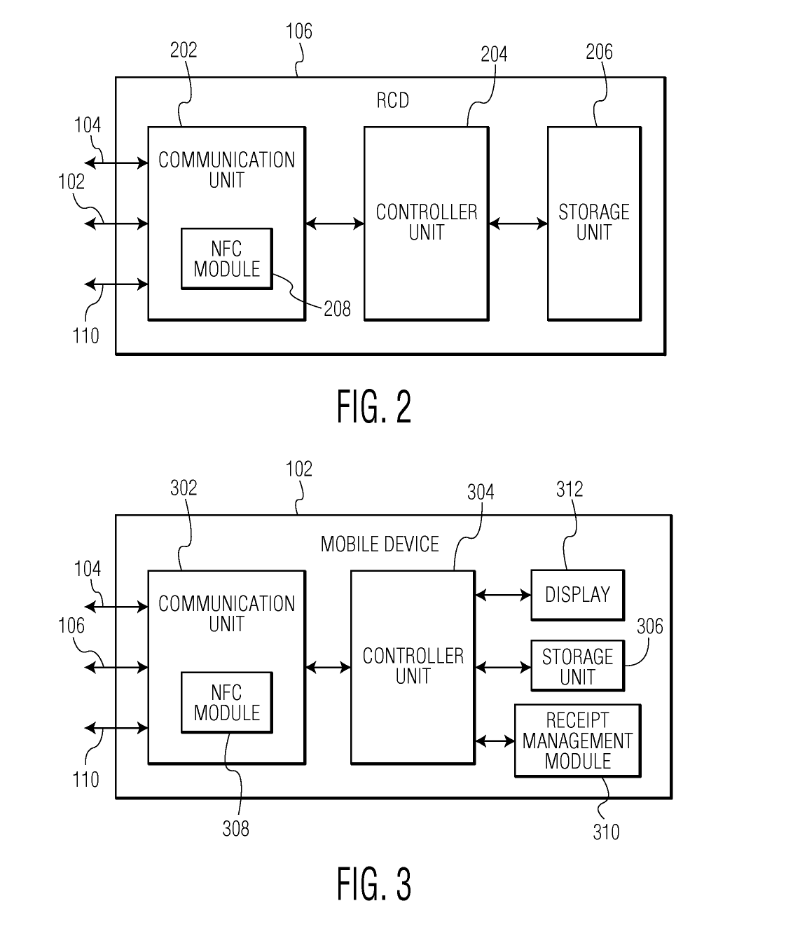

Turning now to FIG. 2, the RCD 106 of the receipt management system 100 in accordance with an embodiment of the invention is shown. In the illustrated embodiment, the RCD 106 is a peripheral device for the POS terminal 104 to capture electronic receipt data for sales transactions, including cash transactions, which are executed using the POS terminal 104. Thus, in the illustrated embodiment, the RCD 106 is an independent device that operates with the POS terminal 104. However, in other embodiments, the RCD 106 may be incorporated into the POS terminal 104 as part of the POS terminal.

As shown in FIG. 2, the RCD 106 includes a communication unit 202, a controller unit 204 and a storage unit 206. The communication unit 202 is configured to establish a wired or wireless communication connection with the POS terminal 104, the mobile device 102, and/or the RCS 110. The communication unit 202 is used to exchange electronic receipt data of sales transactions between the RCD 106 and the POS terminal 104, the mobile device 102, and/or the RCS 110. As an example, the electronic receipt data for a single sales transaction may include merchant information, product information and purchase information. In general, the POS terminal 104 maintains this kind of data for merchant settlement or clearing for a card company in its own storage unit. In the receipt management system 100, the RCD 106 receives such electronic receipt data from the POS terminal 104 using a connection, such as an Ethernet connection, between the communication unit 202 of the RCD 106 and a corresponding communication unit of the POS terminal 104. The RCD 106 can also upload electronic receipt data to the RCS 110 by establishing a communication connection 114 between the RCD and the RCS, which can also be used to download electronic receipt data from the RCS.

The communication unit 202 may also be used to exchange data with the mobile device 102 by establishing a communication link with the mobile device 102. In some embodiments, the communication unit 202 is configured to establish a close proximity connection between the RCD 106 and the mobile device 102 to provide more convenience for the customer, i.e., the user of the mobile device 102, to receive electronic receipt data from the RCD. As an example, the communication unit 202 may include a near field communication (NFC) module 208, which may be an NFC reader/writer or a simple NFC chip, to establish a contactless NFC. However, the communication unit 202 may be configured to establish any close proximity connection, such as a Bluetooth connection. In other embodiments, the RCD 106 may use the POS terminal 104 to exchange data with mobile devices, such as the mobile device 102.

The storage unit 206 of the RCD 106 is used to store electronic receipt data for sales transactions received from the POS terminal 104, which can then be downloaded or transferred to customers' mobile devices, such as the mobile device 102. The storage unit 206 may include one or more memories of any type, such as random access memories and disc storages. In the illustrated embodiment, the storage unit 206 of the RCD 106 is independent of any storage unit of the POS terminal 104. However, in other embodiments, the RCD 106 may not include the storage unit 206 or any other storage device. In these embodiments, the RCD 106 may access the data stored in a storage unit of the POS terminal 104 via the connection established between the POS terminal and the RCD through the communication unit 202.

The storage unit 206 of the RCD 106 provides convenience for both customers and merchants. In some instances, a customer in front of the POS terminal 104 might not have enough time to retrieve the electronic receipt data for a sales transaction at that very moment. For these instances, the RCD 106 is able to stack up the electronic receipt data in the storage unit 106 with previously stored electronic receipt data to give the customer more time to capture the electronic receipt data using his/her mobile device. For that, the merchant might provide a specific zone, for example, next to the POS terminal 104, for customers to capture or receive the electronic receipt data from the RCD 106 using their mobile devices.

The controller unit 204 of the RCD 106 is configured to execute various operations to receive electronic receipt data from the POS terminal 104 and to transmit the electronic receipt data to mobile devices, such as the mobile device 102, when requested by the mobile devices. If the RCD 106 includes the storage unit 206, the controller unit 204 may also be configured to store the received electronic receipt data in the storage unit 206 as long as the electronic receipt data is needed. Thus, the controller unit 204 may include storage management logics to selectively remove the electronic receipt data stored in the storage unit 206 in order to save storage space of the RCD 106. For example, if a merchant using the POS terminal 104 and the RCD 106 establishes a rule on how long the RCD must store the electronic receipt data after the electronic receipt data have been retrieved by customers' mobile devices, such as the mobile device 102, the controller unit 204 executes this receipt management rule. The controller unit 204 can be any type of a microcontroller, a processor or a processing circuitry that is configured to execute the necessary operations of the RCD 106.

Turning now to FIG. 3, the mobile device 102 of the receipt management system 100 in accordance with an embodiment of the invention is shown. The mobile device 102 can be any handheld electronic device, such as a personal digital assistant (PDA), a cellular phone or a multimedia device. As shown in FIG. 3, the mobile device 102 includes at least a communication unit 302, a controller unit 304, a storage unit 306, a receipt management module 310, and a display 312. The mobile device 102 may include other components commonly found in conventional handheld devices, such as a camera, a keypad and speakers.

The communication unit 302 of the mobile device 102 is configured to establish various communication connections for the mobile device. The communication unit 302 may be configured to establish a wired or wireless communication connection 116 with a personal computer (PC) 118, shown in FIG. 1, so that electronic receipt data can be uploaded or transmitted to the personal computer. The communication connection 116 may be a connection via a cable or a network, such as the Internet. The communication unit 302 may also be configured to establish a close proximity connection between the mobile device 102 and the RCD 106 or the POS terminal 104 to provide more convenience for the user of the mobile device to receive electronic receipt data from the RCD. As an example, the communication unit 302 may be configured to establish a contactless near field communication (NFC), which is appropriate when considering the current POS environment in which many POS terminals include NFC readers/writers. However, the communication unit 302 may be configured to establish any close proximity connection, such as a Bluetooth connection.

In some embodiments, the communication unit 302 is used to provide a unique customer identification no., C_No, of the mobile device 102 to the RCD 106 so that the RCD can generate electronic receipt data for a sales transaction using the C_No, and to receive the electronic receipt from the RCD. This C_No is a primary key value to identify a certain user. The C_No may be stored in the mobile device 102, for example, in the storage unit 306.

In some embodiments, the communication unit 302 of the mobile device 102 includes an NFC module 308 to provide NFC functionalities for the mobile device, while the POS terminal 104 includes an NFC reader/writer (not shown). In these embodiments, the NFC module 308 is simply an NFC chip that allows the NFC reader/writer of the POS terminal 104 to read and write data into the NFC module 308. In addition, the C_No is stored in the NFC module 308 so that the C_No can be read from the NFC module by the NFC reader/writer of the POS terminal 104.

The following is a description of an exemplary process of generating electronic receipt data using the C_No stored in the mobile device 102 for embodiments in which the mobile device 102 includes an NFC chip 308 and the POS terminal 104 includes an NFC reader/writer. After a user of the mobile device 102 has made a payment for a sales transaction, the teller asks the user whether the user wants to receive an electronic receipt for the sales transaction. If the user agrees, the teller enables a function that sends receipt data (R_Data) of the sales transaction to the RCD 106. The R_Data includes all the data generated for the sales transaction, such as receipt number (R_No), merchant data (M_Data), product data (P_Data), payment data (Pm_Data), tax data (Tx_Data), tip data (Tp_Data) and promotion data (Pm_Data). At this moment, the NFC reader/writer of the POS terminal 104 reads the C_No in the NFC chip 308 of the mobile device 102 and the POS terminal sends the C_No and R_Data to the RCD 106, which can be considered the electronic receipt data for the sales transaction. The RCD 106 then sends the C_No and the R_Data as the electronic receipt of the sales transaction to the mobile device 102 via NFC through the NFC reader/writer of the POS terminal 104.

In other embodiments, the RCD 106 may include an NFC reader/writer, i.e., the NFC module 208, instead of the POS terminal 104. That is, the RCD 106 includes the optional NFC module 208, which is configured as an NFC reader/writer. In these embodiments, the RCD 106 would read the C_No from the mobile device 102 to generate R_Data and send the C_No and R_Data to the mobile device as an electronic receipt data via NFC.

In other embodiments, the NFC module 308 of the mobile device 102 may be an NFC reader/writer to send the C_No to the RCD 106 and to read the electronic receipt data from the RCD 106. In these embodiments, the RCD 106 includes the optional NFC module 208 that is configured as an NFC chip in which the C_No from the mobile device 102 is stored and in which the generated electronic receipt data is stored.

In a conventional mobile payment process, an NFC enabled mobile device acts as a provider that delivers a credit/debit card number contained in an NFC chip of the mobile device to the NFC reader/writer of a POS terminal. In this process, the mobile device is not used as a reader but merely as a transmitter of the card number. However, in the above embodiments according to the invention, the NFC enabled mobile device 102 acts as a collector that is able to capture all the data related to sales transactions, including data for cash transactions.

The receipt management system 100 does not require the use of NFC communication between mobiles devices, e.g., the mobile device 102, and the POS terminal 104 or the RCD 106. If the POS terminal 104 or the RCD 106 is equipped with an NFC reader/writer, NFC communication is used to provide the C_No stored in the mobile device 102 to the POS terminal or the RCD and to generate the electronic receipt data, which is then sent from the POS terminal or the RCD to the mobile device at the time of the transaction or at a later time. If the POS terminal 104 or the RCD 106 is not NFC-enabled, the mobile device 102 may communicate with the RCD using another type of short range wireless communication connections, such as a Bluetooth connection.

The controller unit 304 of the mobile device 102 is configured to execute operations to perform various functions of the mobile device. In particular, the controller unit 304 is configured to execute operations to receive the electronic receipt data for a sales transaction from the RCD 106 by a communication connection between the mobile device 102 and the RCD and then to store the electronic receipt data in the storage unit 306 of the mobile device. The storage unit 306 may include one or more memories, which may include an internal memory, such as a Universal Subscriber Identity Module (USIM), a subscriber identity module (SIM) or a User Identity Module (UIM), an electrically erasable programmable read-only memory (EEPROM), and/or an extendable memory, such as a secured digital (SD) memory. The controller unit 304 is also configured to upload the electronic data receipt in the storage unit 306 of the mobile device 102 to the personal computer 118 or any other external device, which is selected by the user of the mobile device, via the communication unit 302 of the mobile device. The controller unit 304 can be any type of a microcontroller, processor or processing circuitry that is configured to execute the necessary operations of the mobile device 102.

The receipt management module 310 of the mobile device 102 is configured to provide an application to facilitate transfer of data, including electronic receipt data, between the mobile device 102 and other devices, such as the RCD 106, the RCS 110 and the personal computer 118, and management of the electronic receipt data in the mobile device. If the NFC module 308 of the mobile device 102 is an NFC reader/writer and the NFC module 208 of the RCD 106 is an NFC chip, the receipt management application provided by the receipt management module 310 controls the NFC module 308 to read data, e.g., the electronic receipt data, from the NFC chip of the RCD. In some embodiments, the electronic receipt data may be written into the NFC chip 208 of the RCD 106 by the POS terminal 104. However, if the NFC module 308 of the mobile device 102 is an NFC chip and the NFC module 208 of the RCD 106 is an NFC reader/writer, the receipt management application authorizes data to be written into the NFC chip of the mobile device by the NFC reader/writer of the RCD 106 in response to a request from the RCD to write the data into the NFC chip of the mobile device.

The receipt management application provided by the receipt management module 310 can also compose and display visual receipts on the display 312 of the mobile device 102 using the electronic receipt data stored in any memory accessible by the mobile device, for example, the NFC module 308, the storage unit 306, which may include USIM, SIM(UIM), EEPROM, etc. and any extended memory, such as SD memory. Thus, the receipt management application is able to interface with and read data from all these types of memories, if these memories are available to the mobile device 102. Since the receipt management application is able to interface with the different types of memories, the receipt management application is able to select where to store data, including the electronic receipt data. In some embodiments, the receipt management application provides a selection menu for a user to select which memory or memories to store the electronic receipt data. In other embodiments, the receipt management application automatically selects which memory or memories to store the electronic receipt data. The visual receipts displayed on the display 312 of the mobile device 102 represent a virtual or electronic version of paper receipts. The visual receipts can be displayed in any form. As an example, the visual receipts may appear to be similar in shape to paper receipts, and have information commonly found in paper receipts. However, the visual receipts can be displayed in other displayable formats. The electronic receipt data may also be displayed as a list of receipts with various related information, such as a purchase date, a purchase time, a merchant name, a purchase amount etc. for each sales transaction.

The receipt management application provided by the receipt management module 310 can also provide user interfaces on the display 312 of the mobile device 102 to view electronic receipts, find electronic receipts, delete electronic receipts and edit electronic receipt data, for example, add or delete comments to individual receipt data. For finding particular electronic receipts, any information in the receipt data may be used to search for a specific electronic receipt, such as the purchase date, the merchant name, the receipt number or the receipt type (e.g., original, refunded or exchange receipt).

The receipt management application provided by the receipt management module 310 can also control the uploading of electronic data from the mobile device to the RCS 110 via the communication connection 114 or to the personal computer 118 via the communication connection 116. The uploading speed may be customized by the receipt management application according to the connection capacity. The receipt management application can also control the downloading of electronic data into one or more memories of the mobile device 102 from the RCS 110 via the communication connection 114 or from the personal computer 118 via the communication connection 116.

The receipt management application provided by the receipt management module 310 can also synchronize electronic receipt data between the mobile device 102 and the personal computer 118. The receipt management application is able to compare data headers of the electronic receipt data stored in the mobile device with data headers of the electronic receipt data stored in the personal computer 118. When there are any differences between the electronic receipt data stored in the mobile device 102 and the personal computer 118, the receipt management application is able to make a request for synchronization to the personal computer. Such request for synchronization can also be made from an application running in the personal computer 118 to the mobile device 102.

The receipt management module 310 may be implemented as software executed by the controller unit 304 of the mobile device 102, hardware, firmware, or any combination of software, hardware and firmware. In an embodiment, the receipt management module 310 is a program of instructions executable by the controller unit 304 of the mobile device 102 stored in a computer readable medium, e.g., the storage unit 306, to launch the above application for the mobile device.

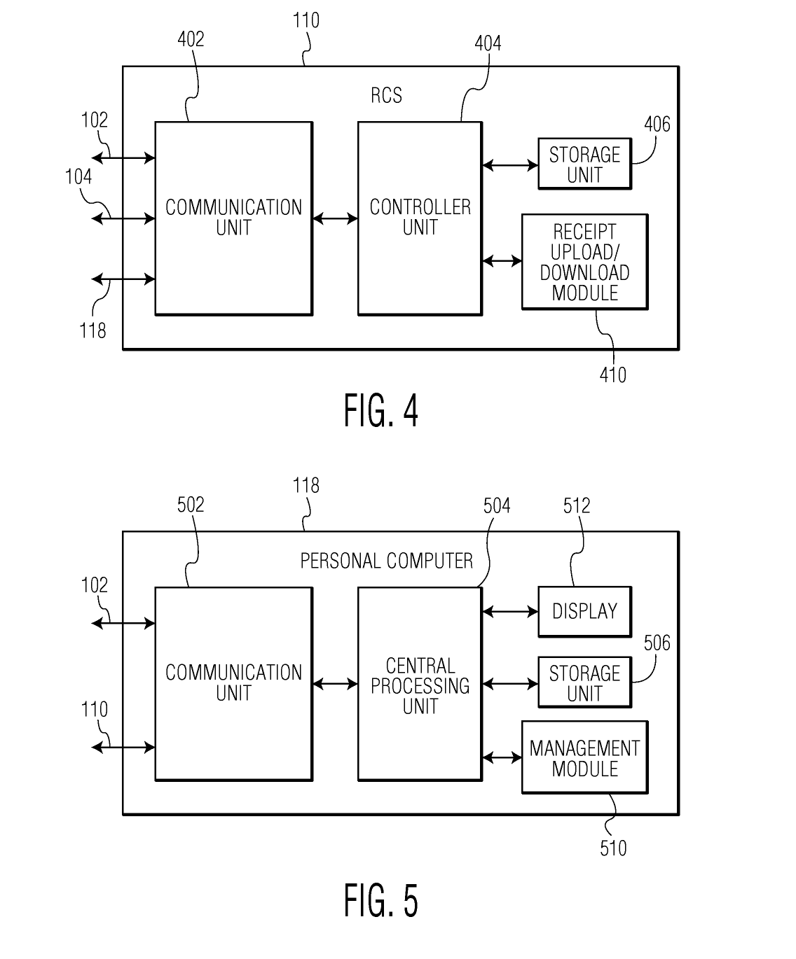

Turning now to FIG. 4, the RCS 110 of the receipt management system 100 in accordance with an embodiment of the invention is shown. The RCS 110 operates to store and manage all electronic receipt data uploaded from the RCD 106, the mobile device 102 or the personal computer 118. The RCS 110 also operates to allow the electronic receipt data to be downloaded to the RCD 106, the mobile device 102 or the personal computer 118 when properly requested.

As shown in FIG. 4, the RCS 110 includes a communication unit 402, a controller unit 404, a storage unit 406 and a receipt upload/download module 410. The communication unit 402 is configured to establish the communication connection 114 with the RCD 106, the mobile device 102 or the personal computer 118. The communication connection 114 is used to upload and download electronic receipt data to and from the RCS 110 by the RCD 106, the mobile device 102 or the personal computer 118. As mentioned above, the communication connection 114 may be a connection via the Internet so that the RCD 106, the mobile device 102, the personal computer 118 or other Internet-enabled devices can communicate with the RCS 110. In other embodiments, the communication connection 114 may be a connection via a physical cable connected between the RCS 110 and the RCD 106 so that only the RCD can access the RCS. Still in other embodiments, the communication connection 114 may be a network connection that can be accessed to connect to the RCS 110.

The storage unit 406 of the RCS 110 is used to store electronic receipt data uploaded from the RCD 106, the mobile device 102 or the personal computer 118, which can then be accessed by the RCD 106, the mobile device 102, or the personal computer 118 as needed. The storage unit 406 may include one or more memories of any type, such as random access memories and disc storages.

In an embodiment, data fields of the storage unit 406 may be as follows to store uploaded electronic receipt data.

| Data Field | Description |
|---|---|
| C_No | Customer identification number |
| R_No | Receipt number |
| M_Data | Merchant Data |
| | {M_No, M_name, M_category} |
| | Merchant number |
| | Merchant name |
| | Merchant category |
| R_Data | Receipt Data |
| | {R_No, M_Data, P_Data, Pm_Data, |
| | Tx_Data, Tp_Data, Pr_Data} |
| P_Data[ ] | Product Data |
| | {P_Code, P_Price, P_name, |
| | P_category} |
| | Product Code |
| | Product Name |
| | Product Price |
| | Product Category |
| Pm_Data | Payment Data |
| | {Pm_Type, Pm_name} |
| | Payment Type |
| | Payment Name |
| Tx_Data | Tax Data |
| | {Tx_Rate, Tx_amount} |
| | Tax Rate |
| | Tax amount |
| Tp_Data | Tip Data |
| | {Tp_amount} |
| | Tip amount |
| Pr_Data | Promotion Data |
| | {Pr_Code, Pr_name, Pr_amount, |
| | Pr_rate, Pr_dsc, Pr_expire_date} |
| | Promotion code |
| | Promotion name |
| | Promotion discount amount |
| | Promotion discount rate |
| | Promotion description |
| | Promotion expiration date |

The controller unit 404 of the RCS 110 is configured to execute operations to perform various functions of the RCS. In particular, the controller 404 is configured to execute operations to upload electronic receipt data from the RCD 106, the mobile device 102 or the personal computer 118 through the communication connection 114 and to store the electronic receipt data in the storage unit 406 of the RCS 110. The controller unit 404 is also configured to execute operations to download the electronic receipt data in the storage unit 406 of the RCS 110 to requesting devices upon valid requests. The controller unit 404 can be any type of a microcontroller, processor or processing circuitry that is configured to execute the necessary operations of the RCS 110.

The receipt upload/download module 410 of the RCS 110 is configured to provide an application to manage the electronic receipt data stored in the storage unit 406 of the RCS. This receipt management application provided by the receipt upload/download module 410 manages the uploading of electronic receipt data to the RCS 110 and downloading of electronic receipt data from the RCS upon valid requests. The receipt upload/download module 410 may be implemented as software executed by the controller unit 404 of the RCS 110, hardware, firmware, or any combination of software, hardware and firmware. In an embodiment, the receipt upload/download module 410 is a program of instructions executable by the controller unit 404 of the RCS 110 stored in a computer readable medium, e.g., the storage unit 406, to launch the above application.

Turning now to FIG. 5, the personal computer 118 of the receipt management system 100 in accordance with an embodiment of the invention is shown. The personal computer 118 includes a communication unit 502, a central processing unit 504, a storage unit 506 and a display 512, which are found in conventional personal computers. Thus, these components are not described herein in detail. The communication unit 502 is configured to establish the communication connection 116 with the mobile device 102 and to establish the communication connection 114 with the RCS 110. The storage unit 506 of the personal computer 118 can be used to store electronic receipt data received from the mobile device 102 and/or the RCS 110, as well as other data used by the personal computer. The storage unit 506 may include one or more memories of any type, such as random access memories and disc storages. The central processing unit 504 of the personal computer 118 is configured to execute operations to perform various functions of the personal computer. The personal computer 118 may also include components that are commonly found in conventional personal computers.

The personal computer 118 also includes a management module 510 that is configured to provide an application to facilitate downloading and uploading of electronic receipt data from and to the mobile device 102 and/or the RCS 110. This management application provided by the management module 510 can also be used to manage the electronic receipt data stored in the personal computer 118, which may be displayed on the display 512 in any suitable format.

The management application provided by the management module 510 can also compose and display visual receipts on the display 512 of the personal computer 118 using the electronic receipt data stored in any memory accessible by the personal computer, such as the storage unit 506. The electronic receipt data may also be displayed as a list of receipts with various related information, such as a purchase date, a purchase time, a merchant name, a purchase amount, etc. for each sales transaction.

Similar to the receipt management application of the mobile device 102, the management application provided by the management module 510 can also provide user interfaces on the display 512 of the personal computer 118 to view electronic receipts, find electronic receipts, delete electronic receipts and edit electronic receipt data, for example, add or delete comments to individual receipt data. For finding particular electronic receipts, any information in the receipt data may be used to search for a specific electronic receipt, such as the purchase date, the merchant name, the receipt number or the receipt type (e.g., original, refunded or exchange receipt).

The management application provided by the management module 510 can also control the communication unit 502 of the personal computer 118 to establish the communication connection 116 between the personal computer and the mobile device 102, which can be a USB connection or a short range wireless connection such as a Bluetooth connection, to transfer data between the personal computer and the mobile device. The management application can also control the communication unit 502 to establish the communication connection 114 between the personal computer 118 and the RCS 110, which can be an Internet connection.

The management application provided by the management module 510 can also synchronize electronic receipt data between the personal computer 118 and the mobile device 102. When there are any differences between the electronic receipt data stored in the personal computer 118 and the mobile device 102, the management application is able to make a request for synchronization to the mobile device. In some embodiments, most of the electronic receipt data that are initially stored in the mobile device 102 can be transferred to the personal computer 118 to reduce the amount of electronic receipt data stored in the mobile device to overcome the storage limit of the mobile device. In these embodiments, when the electronic receipt data are transferred to the personal computer 118 for storage, one or more pieces of information of the electronic receipt data, such as the receipt number, remain (left undeleted) at the mobile device 102 so that these remaining information can be used for subsequent retrieval of the electronic receipt data by the mobile device and for synchronization. When the mobile device 102 receives new electronic receipt data, the management application is able to fetch the new electronic receipt data and store the data at the personal computer 118.

The management application provided by the management module 510 can also synchronize electronic receipt data between the personal computer 118 and the RCS 110. The management application is able to upload or download the electronic receipt data to and from the RCS 110 to synchronize between the personal computer 118 and the RCS or synchronize between the mobile device 102, the RCS and the personal computer.

The management module 510 may be implemented as software executed by the central processing unit 504 of the personal computer 118, hardware, firmware, or any combination of software, hardware and firmware. In an embodiment, the management module 510 is a program of instructions executable by the central processing unit 504 of the personal computer 118 stored in a computer readable medium, e.g., the storage unit 506, to launch the above PC application.

In some embodiments, electronic receipt information can be stored in more than one device. As an example, the electronic receipt information may be stored in the mobile device 102, the RCS 110 and the personal computer 118. In these embodiments, the electronic receipt information stored in the difference devices may be synchronized using the receipt number (R_No), not the receipt data (R_Data), to save space in the mobile device 102. The receipt data can be downloaded to the mobile device 102 from the RCS 110 or the personal computer 118 as needed.

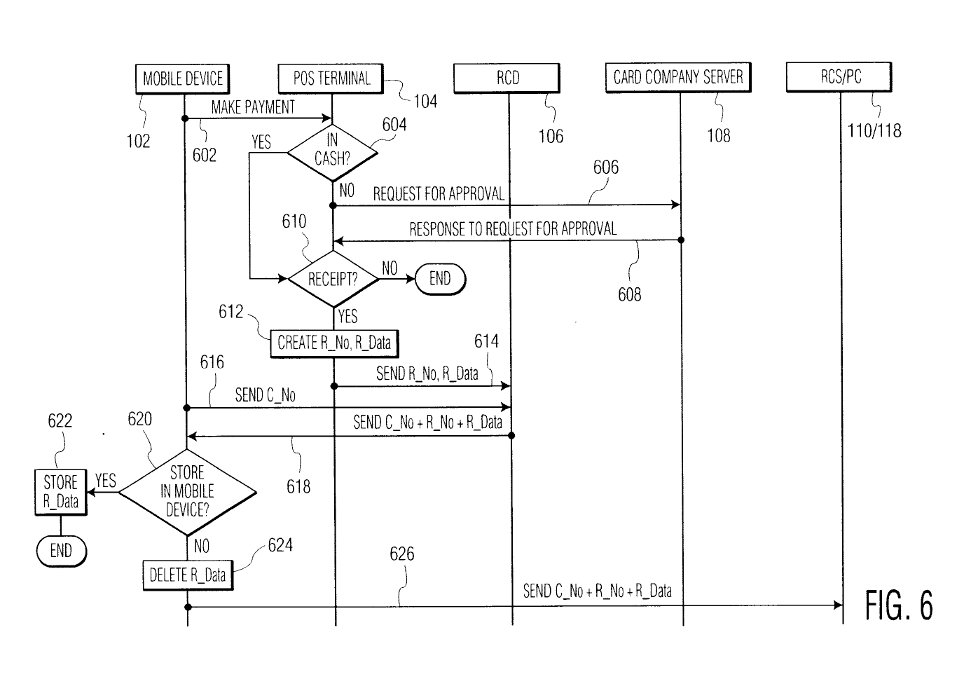

A process of managing (capturing, issuing and storing) electronic receipts using the receipt management system 100 in accordance with a first embodiment of the invention is described with reference to a flow diagram of FIG. 6. In this embodiment, the RCD 106 is a device independent of the POS terminal 104. That is, the RCD 106 is not integrated into the POS terminal 104. As an example, the RCD 106 may be a peripheral device that is connected to the POS terminal 104. Furthermore, in this embodiment, the user identification (C_No) is used to associate sales transactions with a particular user when electronic receipts are generated. The C_No is stored in the mobile device 102.

After a sales transaction, the user of the mobile device 102 makes a payment for the sales transaction to the POS terminal 104, at step 602. Next, at step 604, a determination is made whether the payment is made in cash. If the payment is made in cash, then the process proceeds to step 610. However, if the payment is not made in cash, then a request for an approval is transmitted from the POS terminal 104 to the card company server 108, at step 606. In response to the request, an approval response or a denial response is sent to the POS terminal 104 from the card company server 108, at step 608. If the request is denied, then the process comes to an end. If the request is approved, then the process proceeds to step 610.

At step 610, a determination is made whether the user of the mobile device 102 wants an electronic receipt for the sales transaction. This may involve the teller asking the user of the mobile device 102 if the user wants an electronic receipt for the sales transaction. If the user of the mobile device 102 does not want an electronic receipt, then the process comes to an end. However, if the user of the mobile device 102 does want an electronic receipt, then the process proceeds to step 612, where R_No and R_Data for the sales transaction are generated by the POS terminal 104. The R_No and the R_Data are then transmitted to the RCD 106, at step 614.

In addition, at step 616, the C_No is transmitted from the mobile device 102 to the RCD 106. If the POS terminal 104 includes an NFC reader/writer, the POS terminal reads the C_No from the mobile device 102 and transmits the C_No to the RCD 106. If the mobile device 102 includes an NFC reader/writer, the mobile device may send the C_No to the RCD 106. Alternatively, other means of communication, such as a Bluetooth connection, may be used to transmit the C_No to the RCD 106.

Next, at step 618, an electronic receipt that includes the C_No, the R_No and the R_Data is transmitted from the RCD 106 to the mobile device 102. If the POS terminal 104 includes an NFC reader/writer, the RCD 106 sends the electronic receipt to the mobile device 102 via the POS terminal. If the mobile device 102 includes an NFC reader/writer, the mobile device may simply read the electronic receipt from the RCD 106. Alternatively, other means of communication, such as a Bluetooth connection, may be used to transmit the electronic receipt from the RCD 106 to the mobile device 102.

Next, at step 620, a determination is made whether the user wants to store the electronic receipt in the mobile device 102. In some embodiments, the application provided by the receipt management module 310 of the mobile device 102 may prompt the user to input a decision whether to store the electronic receipt in the mobile device. In other embodiments, the application provided by the receipt management module 310 of the mobile device 102 may be set to automatically store electronic receipts in the mobile device or to transmit the electronic receipts to the RCS 110 and/or the personal computer 118.

If the user wants to store the electronic receipt in the mobile device 102, the electronic receipt is stored in the storage unit 306 of the mobile device by the application provided by the receipt management module 310, at step 622. The process then comes to an end. However, if the user does not want to store the electronic receipt in the mobile device 102, the R_Data is deleted from the mobile device, at step 624, and the C_No, the R_No and the R_Data are transmitted to the RCS 110 and/or the personal computer 118 to be stored, at step 626, which allows the user to subsequently retrieve the electronic receipt from the RCS 110 and/or the personal computer 118 as needed. The process then comes to an end.

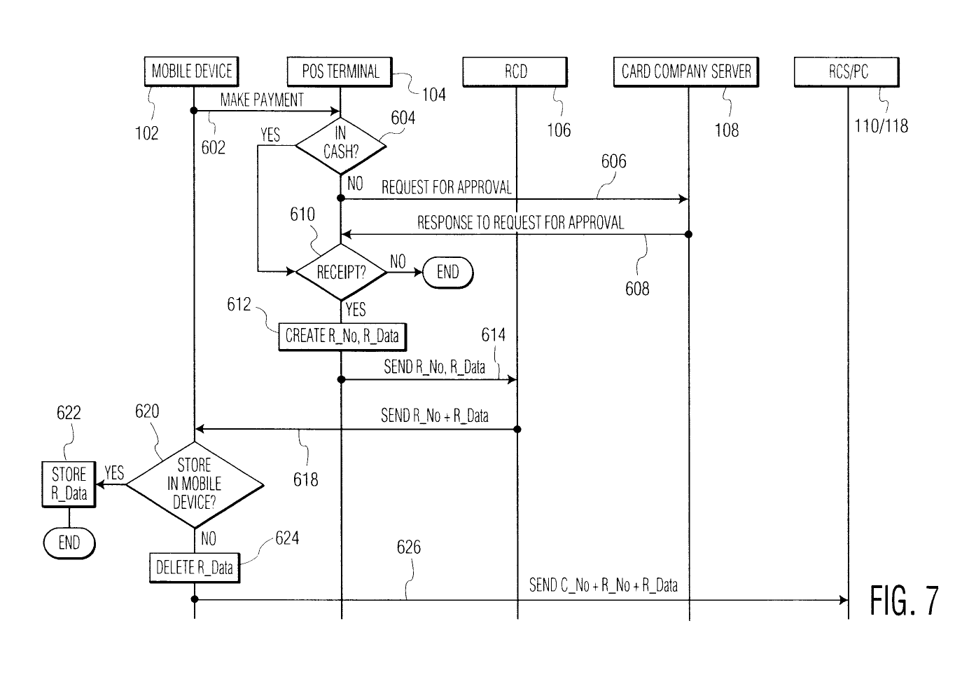

A process of managing (capturing, issuing and storing) electronic receipts in the receipt management system 100 in accordance with a second embodiment of the invention is described with reference to a flow diagram of FIG. 7. Similar to the first embodiment, the RCD 106 is a device independent of the POS terminal 104 in this embodiment. In addition, in this embodiment, the user identification (C_No) is used to associate sales transactions with a particular user when electronic receipts are generated. The C_No is stored in the mobile device 102.

As illustrated in FIG. 7, the process of managing electronic receipts using the receipt management system 100 in accordance with the second embodiment includes the same steps as the first embodiment except for step 616, which is omitted. Thus, in this second embodiment, the C_No is not transmitted from the mobile device 102 to the RCD 106. Consequently, the electronic receipt data received by the mobile device 102 from the RCD 106 does not include the C_No. However, the electronic receipt data uploaded to the RCS 110 or the personal computer 118, at step 626, may include the C_No. This embodiment can be implemented when there is a concern regarding associating user identification with electronic receipts. Some users may feel uncomfortable that information about sales transactions, which can be linked to the individual users, is being stored in devices beyond their control. Thus, in this embodiment, the electronic receipts are not linked to individual users using the C_No, which alleviates users' concern regarding the storage of “personal” information.

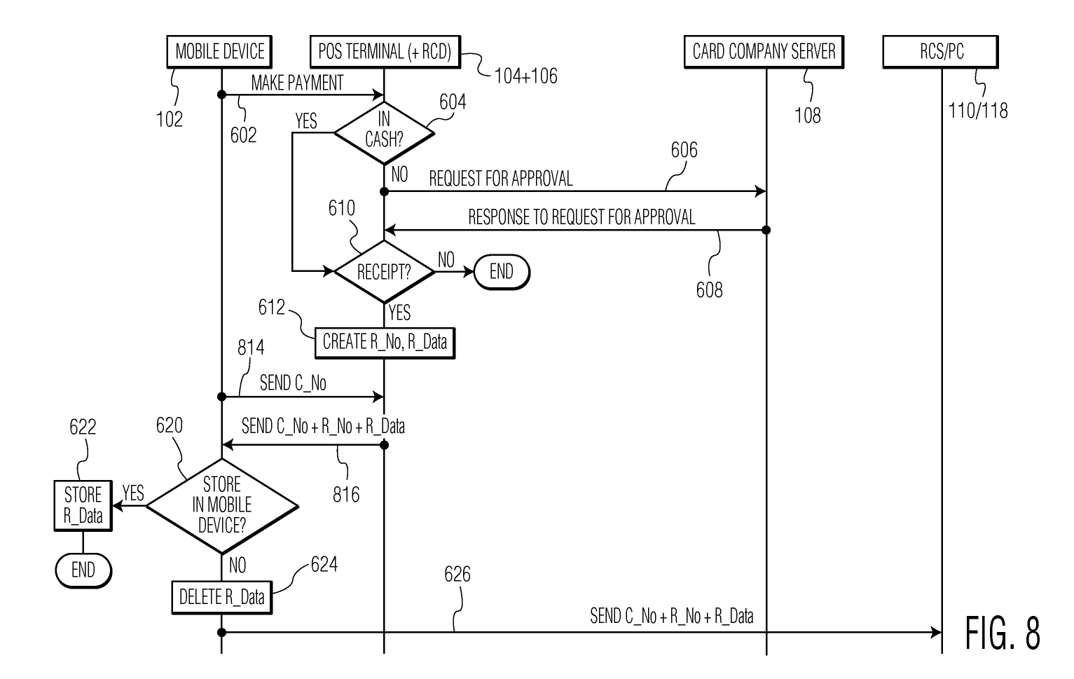

A process of managing (capturing, issuing and storing) electronic receipts using the receipt management system 100 in accordance with a third embodiment of the invention is described with reference to a flow diagram of FIG. 8. In this embodiment, the RCD 106 is not a device independent of the POS terminal 104. That is, the RCD 106 is integrated into the POS terminal 104. In this embodiment, the user identification (C_No) is used to associate sales transactions with a particular user. The C_No is stored in the mobile device 102.

As illustrated in FIG. 8, the process of managing electronic receipts using the receipt management system 100 in accordance with the third embodiment includes the same steps 602-612 and 620-626 as the process in accordance with the first embodiment. Thus, the descriptions of these steps 602-612 and 620-626 are not repeated.

After step 612, the process proceeds to step 814. At step 814, the C_No is transmitted from the mobile device 102 to the POS terminal 104, which includes the RCD 106 in this third embodiment. If the POS terminal 104 includes an NFC reader/writer, the POS terminal reads the C_No from an NFC chip of the mobile device, i.e., the NFC module 308 configured as an NFC chip. If the mobile device 102 includes an NFC reader/writer, i.e., the NFC module 308 configured as an NFC reader/writer, the mobile device may send the C_No to the POS terminal 104. Alternatively, other means of communication, such as a Bluetooth connection, may be used to transmit the C_No from the mobile device 102 to the POS terminal 104.

Next, at step 816, an electronic receipt data that includes the C_No, the R_No and the R_Data is transmitted from the POS terminal 104 to the mobile device 102. If the POS terminal 104 includes an NFC reader/writer, the POS terminal sends the electronic receipt data to an NFC chip of the mobile device, i.e., the NFC module 308 configured as an NFC chip. If the mobile device 102 includes an NFC reader/writer, i.e., the NFC module 308 configured as an NFC reader/writer, the mobile device may simply read the electronic receipt from the RCD 106, which is part of the POS terminal 104 in this third embodiment. Alternatively, other means of communication, such as a Bluetooth connection, may be used to transmit the electronic receipt from the RCD 106 to the mobile device 102.

After step 816, the process proceeds to step 620 to see if the user wants to store the electronic receipt in the mobile device 102, the RCS 110 or the personal computer 118. As noted above, steps 620-626 in this process in accordance with the third embodiment are the same steps as the process in accordance with the first embodiment. This process of managing electronic receipts in the receipt management system 100 in accordance with the third embodiment can also be implemented without transmitting the C_No to the POS terminal 104 with the RCD 106, similar to the process in accordance with the second embodiment.

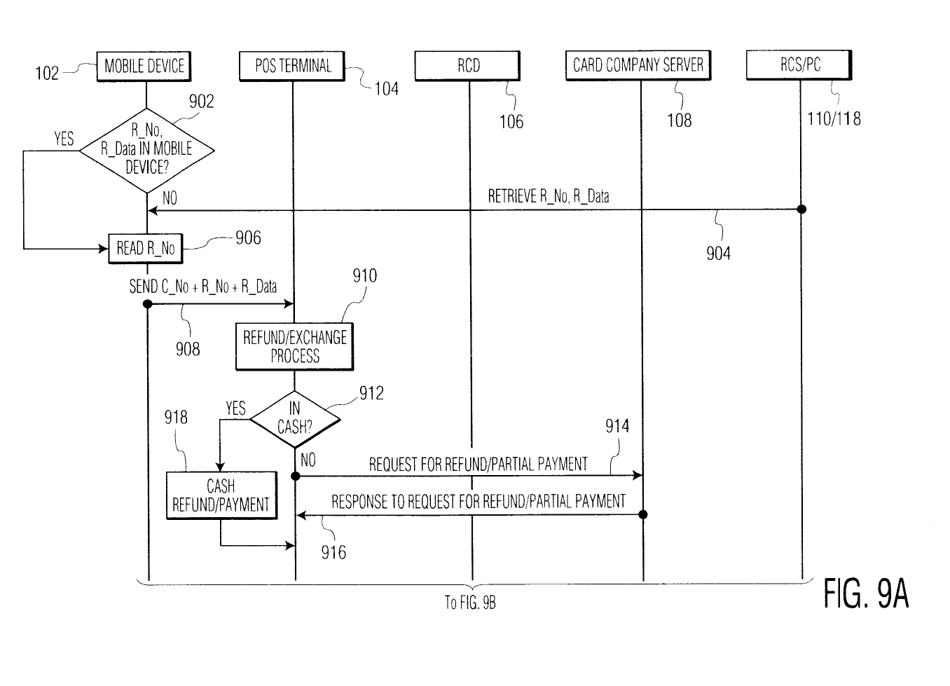

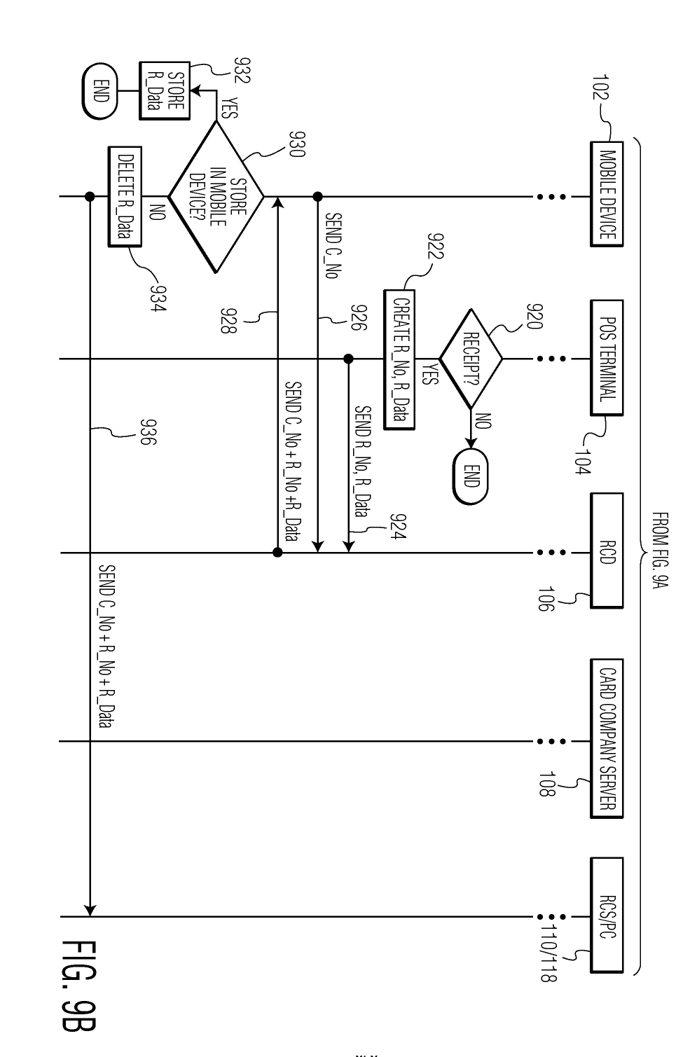

A process of getting a refund/exchange using the receipt management system 100 in accordance with an embodiment of the invention is described with reference to flow diagrams of FIGS. 9A and 9B. In this embodiment, the RCD 106 is a device independent of the POS terminal 104. That is, the RCD 106 is not integrated into the POS terminal 104. As an example, the RCD 106 may be a peripheral device that is connected to the POS terminal 104. Furthermore, in this embodiment, the user identification (C_No) is used to associate sales transactions with a particular user when electronic receipts are generated. The C_No is stored in the mobile device 102.

The refund/exchange process begins at step 902 in FIG. 9A, where a determination is made whether the R_No and the R_Data for the previous sales transaction are in the mobile device 102. This step may involve the user of the mobile device 102 to launch the receipt management application in the mobile device and selecting the correct electronic receipt or sales transaction for the refund/exchange to see if the R_No and the R_Data are currently stored in the mobile device. If yes, then the process proceeds to step 906. If no, then the R_No and the R_Data are retrieved from the RCS 110 or the personal computer 118, at step 904, which may involve using a view function in a transaction list downloaded from the RCS or the personal computer.

At step 906, the R_No and the R_Data for the previous sales transaction are read by the mobile device 102. Next, at step 908, the R_No and the R_Data for the previous sales transaction are transmitted to the POS terminal 104. The transmission of the R_No and the R_Data to the POS terminal 104 may involve NFC or other short range communication.

Next, at step 910, the R_No and the R_Data are used to process the refund/exchange. Thus, the user of the mobile device 102 can get a refund or an exchange without having to carry paper receipts. During step 910, the R_No and the R_Data are authenticated to authorize the refund/exchange. In order to increase security, check-digit logics and a merchant unique code might be verified to authenticate the R_No and the R_Data.

Next, at step 912, a determination is made whether the previous sales transaction was paid in cash. If the previous sales transaction was paid in cash, the refund or the price difference from the exchange is paid to the user of the mobile device 102 or the balance from the exchange is paid by the user, at step 918. The process then proceeds to step 920 in FIG. 9B. However, if the previous sales transaction was not paid in cash, i.e., paid using a debit or credit card, a request for refund or partial refund (or a request for approval of balance payment) is made to the card company server 108 from the POS terminal 104, at step 914. Next, a response to the request from the card company server 108 is received at the POS terminal 104, at step 916.

After completing the refund/exchange, an electronic receipt is generated for the refund/exchange in a manner similar to a regular sales transaction, if the user of the mobile device 102 wants the electronic receipt. Thus, the following description is similar to the description of the process of managing electronic receipts in accordance with the first embodiment, which was previously described with reference to FIG. 6.

At step 920 in FIG. 9B, a determination is made whether the user of the mobile device 102 wants an electronic receipt for the refund/exchange. This may involve the salesperson asking the user the mobile device 102 if the user wants an electronic receipt for the refund/exchange. If the user of the mobile device 102 does not want an electronic receipt, then the process comes to an end. However, if the user of the mobile device 102 does want an electronic receipt, then the process proceeds to step 922, where R_No and R_Data for the sales transaction are generated by the POS terminal 104. The R_No and the R_Data are then transmitted to the RCD 106, at step 924.

In addition, at step 926, the C_No is transmitted from the mobile device 102 to the RCD 106 using, for example, NFC or other short range communication. Next, at step 928, an electronic receipt that includes the C_No, the R_No and the R_Data is transmitted from the RCD 106 to the mobile device 102 using, for example, NFC or other short range communication.

Next, at step 930, a determination is made whether the user wants to store the electronic receipt in the mobile device 102. In some embodiments, the application provided by the receipt management module 310 of the mobile device 102 may prompt the user to input a decision whether to store the electronic receipt in the mobile device. In other embodiments, the application provided by the receipt management module 310 of the mobile device 102 may be set to automatically store electronic receipts in the mobile device or to transmit the electronic receipt to the RCS 110 or the personal computer 118.

If the user wants to store the electronic receipt in the mobile device 102, the electronic receipt is stored in the storage unit 306 of the mobile device by the application provided by the receipt management module 310, at step 932. The process then comes to an end. However, if the user does not want to store the electronic receipt in the mobile device 102, the R_Data is deleted from the mobile device, at step 934, and the C_No, the R_No and the R_Data are transmitted to the RCS 110 or the personal computer 118 to be stored, at step 936, which allows the user to subsequently retrieve the electronic receipt as needed. The process then comes to an end.

In the above process for getting a refund/exchange, the old electronic receipt will be marked as “refunded or exchanged.” Thus, two electronic receipts are stored in the storage of the mobile device 102, the RCS 110 and/or the personal computer 118 for further usage of the receipts by the customer, i.e., the user of the mobile device 102.

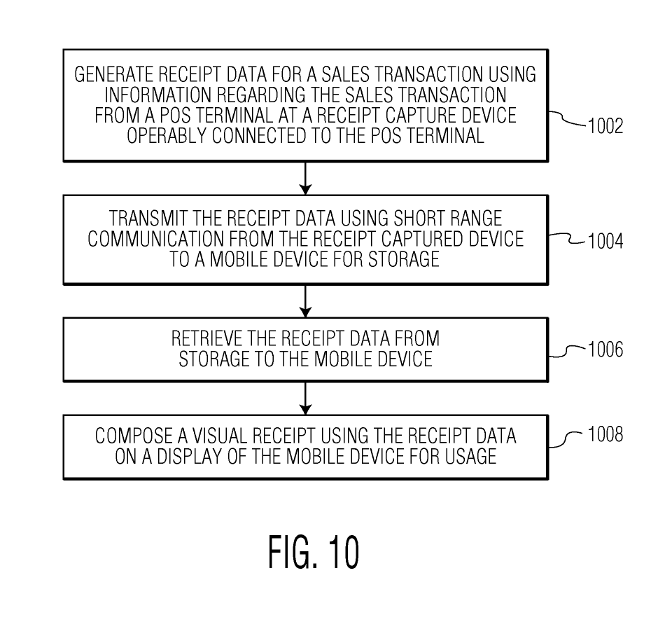

A method for managing electronic receipts of sales transactions in accordance with an embodiment of the invention is described with reference to a flow diagram of FIG. 10. At block 1002, receipt data for a sales transaction is generated using information regarding the sales transaction from a point-of-sales (POS) terminal at a receipt capture device operably connected to the POS terminal. Next, at block 1004, the receipt data is transmitted using short range communication from the receipt captured device to a mobile device for storage. Next, at block 1006, the receipt data is retrieved from storage to the mobile device. Next, at block 1008, a visual receipt is composed using the receipt data on a display of the mobile device for usage

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for managing electronic receipts of sales transactions, the method comprising:
generating receipt data for a sales transaction using information regarding the sales transaction from a point-of-sales (POS) terminal at a receipt capture device operably connected to the POS terminal;
transmitting the receipt data using short range communication from the receipt captured device to a mobile device for storage;
retrieving the receipt data from storage to the mobile device; and
composing a visual receipt using the receipt data on a display of the mobile device for usage.

2. The method of claim 1 further comprising:
composing visual receipts on the display of the mobile device for a user to select a particular visual receipt to be used for a refund or an exchange;
transmitting receipt data for the particular visual receipt using the short range communication from the mobile device to the POS terminal;
processing the refund or the exchange at the POS terminal using the receipt data for the particular visual receipt; and
generating new receipt data for the refund or the exchange.

3. The method of claim 1 further comprising:
establishing a communication connection between the mobile device and a personal computer; and
transferring at least some of the receipt data from the mobile device to a personal computer to reduce the amount of data being stored in the mobile device.

4. The method of claim 3 wherein the establishing the communication connection comprises establishing an Internet connection or a short range wireless connection between the mobile device and the personal computer.

5. The method of claim 1, wherein the transmitting the receipt data comprises transmitting the receipt data using near field communication (NFC) from the receipt captured device to the mobile device.

6. The method of claim 5, wherein the transmitting the receipt data further comprises reading the receipt data from the receipt capture device using an NFC reader of the mobile device.

7. The method of claim 1 further comprising:
establishing a communication connection between the mobile device and a remote server; and
exchanging data, including the receipt data, between the mobile device and the remote server.

8. A system for managing electronic receipts of sales transactions, the system comprising:
a point-of-sales (POS) terminal;
a receipt capture device operably connected to the POS terminal, the receipt capture device being configured to generate receipt data for a sales transaction using information regarding the sales transaction from the POS terminal, the receipt capture device being further configured to transmit the receipt data using short range communication; and
a mobile device configured to receive the receipt data using the short range communication with the receipt capture device, the mobile device being further configured to compose a visual receipt for the sales transaction using the receipt data on a display of the mobile device for usage.

9. The system of claim 8, wherein the mobile device is further configured to compose visual receipts on the display of the mobile device for a user to select a particular visual receipt to be used for a refund or an exchange and to transmit receipt data for the particular visual receipt using the short range communication from the mobile device to the POS terminal or from the mobile device through the receipt capture device to the POS terminal, wherein the POS terminal is configured to process the refund or the exchange using the receipt data for the particular visual receipt, and wherein the receipt capture device is configured to generate new receipt data for the refund or the exchange.

10. The system of claim 8, wherein the mobile device is configured to establish a communication connection between the mobile device and a personal computer and to transfer at least some of the receipt data from the mobile device to a personal computer to reduce the amount of data being stored in the mobile device.

11. The system of claim 10, wherein the mobile device is configured to establish the communication connection that comprises an Internet connection or a short range wireless connection between the mobile device and the personal computer.

12. The system of claim 8, wherein the mobile device includes a near field communication (NFC) module to receive the receipt data from the receipt captured device.

13. The system of claim 12, wherein the NFC module of the mobile device is an NFC reader to read the receipt data from the receipt capture device.

14. The system of claim 8, wherein the mobile device is configured to establish a communication connection with a remote server to exchange data, including the receipt data.

15. A receipt capture device comprising:
a controller unit operably connected to a point-of-sales (POS) terminal and a storage unit, the controller unit being configured to receive information regarding a sales transaction from the POS terminal, the controller unit being further configured to generate receipt data for the sales transaction using the information from the POS terminal and to store the receipt data in the storage unit, the controller unit being further configured to transmit the receipt data to a mobile device using short range communication, the controller unit being further configured to selectively delete the receipt data from the storage unit after the receipt data has been transmitted to the mobile device according to an established receipt management rule, the controller unit being further configured to store receipt data for multiple sales transactions in a sequential manner and to associate the receipt data for the multiple sales transactions with unique user identifiers to distinguish each sales transaction, the controller unit being further configured to be able to upload and download the receipt data for any sales transaction to and from a remote server to avoid overflow of data at the storage unit.

16. The receipt capture device of claim 15, further comprising a near field communication (NFC) module to transmit the receipt data to the mobile device.

17. The receipt capture device of claim 16, wherein the NFC module is an NFC writer to write the receipt data into an NFC chip of the mobile device or wherein the NFC module includes an NFC chip so that an NFC reader of the mobile device can read the receipt data from the NFC chip of the receipt capture device.

18. A computer readable medium tangibly embodying a program of instructions executable by a processor of a mobile device to perform method steps for managing electronic receipts of sales transactions, the method steps comprising:
receiving receipt data for a sales transaction from a receipt capture device associated with a point-of-sales (POS) terminal using short range communication;
storing the receipt data for the sales transaction received from the receipt capture device in a storage unit of the mobile device;
composing a visual receipt for the sales transaction using the receipt data in the storage unit on a display of the mobile device;
uploading the receipt data from the mobile device to a remote device for storage, including deleting the receipt data from the storage unit of the mobile device; and
downloading the receipt data from the remote device to the mobile device.

19. The computer readable medium of claim 18, wherein the remote device is a personal computer or a remote server, and wherein the method steps further comprises establishing a communication connection between the mobile device and the personal computer or between the mobile device and the remote server.

20. The computer readable medium of claim 18, wherein the storing the receipt data for the sales transaction includes writing the receipt data in a memory of the mobile device, the memory being selected from a group consisting of a near field communication (NFC) chip, a Universal Subscriber Identity Module (USIM), a subscriber identity module (SIM), an electrically erasable programmable read-only memory (EEPROM) and a secured digital (SD) memory.

21. The computer readable medium of claim 18, wherein the method steps further comprises:
composing visual receipts on the display of the mobile device using receipt data for multiple sales transactions; and
allowing a user to search for a specific visual receipt using a piece of information in the receipt data for the multiple sales transactions, the piece of information being selected from a group consisting of a purchase date, a purchase time, a merchant name and a purchase amount.

22. A computer readable medium tangibly embodying a program of instructions executable by a processor of a computer to perform method steps for managing electronic receipts of sales transactions, the method steps comprising:
receiving receipt data for a sales transaction from a mobile device;
storing the receipt data received from the mobile device in a storage unit of the computer;
composing a visual receipt on a display of the personal computer using the receipt data; and
transmitting the receipt data to the mobile device when requested by the mobile device.

23. The computer readable medium of claim 22, wherein the method steps further comprises:
composing visual receipts on the display of the personal computer using receipt data for multiple sales transactions; and
allowing a user to search for a specific visual receipt using a piece of information in the receipt data for the multiple sales transactions, the piece of information being selected from a group consisting of a purchase date, a purchase time, a merchant name and a purchase amount.
